(19) United States
(12) Patent Application Publication
(10) Pub. No.: US 2025/0046071 A1
(43) Pub. Date: Feb. 6, 2025

(54) TEMPORAL AGGREGATION FOR DYNAMIC CHANNEL PRUNING AND SCALING

(71) Applicant: SAMSUNG ELECTRONICS CO., LTD., SUWON-SI (KR)

(72) Inventors: Ishay Goldin, Tel-Aviv (IL); Avraham Raviv, Tel-Aviv (IL); Yonatan Dinai, Tel-Aviv (IL); Nimrod Harel, Tel-Aviv (IL); Niv Zehngut, Tel-Aviv (IL)

(21) Appl. No.: 18/755,803

(22) Filed: Jun. 27, 2024

Related U.S. Application Data
(60) Provisional application No. 63/517,695, filed on Aug. 4, 2023.

(51) Int. Cl. G06V 10/82; G06V 10/77; G06V 20/40

(52) U.S. Cl. CPC G06V 10/82; G06V 10/7715; G06V 20/41

(57) ABSTRACT

Aspects of the method, apparatus, non-transitory computer readable medium, and system include obtaining a video comprising a plurality of video frames; computing, using a machine learning model, a global dependency value based on the plurality of video frames; deactivating a filter of the machine learning model based on the global dependency value; and processing, using the machine learning model, at least a portion of the video based on the deactivated filter.

### CROSS-REFERENCE TO RELATED APPLICATIONS

The following disclosure relates to and claims the benefit under 35 USC § 120 of U.S. Provisional Patent Application No. 63/517,695, filed on Aug. 4, 2023, in the U.S. Patent Office, the contents of which are incorporated by reference herein in in its entirety.

### BACKGROUND

Large neural networks have the capacity to learn more difficult functions at the cost of increased computational complexity. Larger network models can also use more memory and storage space, which makes them harder to distribute. Deep learning involves the design of neural architectures that can be efficiently and effectively trained to perform well in a given task. Neural network designs with billions of parameters have demonstrated high-level capabilities, but at the cost of significant computational complexity. Larger models also take more time to run and can require more expensive hardware. Mobile devices and embedded devices, including autonomous driving devices, can be smaller systems that have limited computing power and limited memory.

Analyzing videos involves processing multiple video (image) frames. Large neural networks have been applied to machine vision and video processing tasks, but these can utilize significant memory and computing power, that are lacking on smaller systems. Relatively light weight backbones, such and MobileNets and EfficientNets, have been trained for specific problems.

### SUMMARY

Embodiments of the present disclosure provide a method and system for reducing the network computational needs for many computer vision and video processing tasks.

Aspects of the method, apparatus, non-transitory computer readable medium, and system include obtaining a video comprising a plurality of video frames; computing, using a machine learning model, a global dependency value based on the plurality of video frames; deactivating a filter of the machine learning model based on the global dependency value; and processing, using the machine learning model, at least a portion of the video based on the deactivated filter.

A method, apparatus, non-transitory computer readable medium, and system for dynamic channel pruning are described. One or more aspects of the method, apparatus, non-transitory computer readable medium, and system include receiving a plurality of video frames; generating, using a machine learning model, features corresponding to each of the plurality of video frames; identifying a temporally consistent feature of the plurality of video frames based on the features; and deactivating a filter of the machine learning model based on the temporally consistent feature.

An apparatus and system for a video analysis system are described. One or more aspects of the apparatus and system include one or more processors, and memory coupled to the one or more processors, wherein the memory includes instruction for: a global average pooling (GAP) component configured to generate a global descriptor for each of a plurality of video frames, a temporal attention component (TAC) configured to capture global dependencies between video frames based on the global descriptors and output a processed global descriptor, a concatenation component configured to concatenate the processed global descriptor with the corresponding global descriptor, and a policy head configured to generate a mask from the concatenated processed global descriptor and corresponding global descriptor, wherein the mask identifies deactivated convolution filters.

### BRIEF DESCRIPTION OF THE DRAWINGS

FIG. 1 is an illustrative depiction of a schematic diagram showing an attention mechanism applied to dynamic channel pruning and scaling, according to aspects of the present disclosure.

FIG. 2 is an illustrative depiction of a schematic diagram showing a temporal aggregation policy for dynamic channel pruning and scaling for two consecutive video frames, according to aspects of the present disclosure.

FIG. 3 shows a block diagram of an example of a policy network head architecture, according to aspects of the present disclosure.

FIG. 4 is a schematic diagram of an implementation of a temporal aggregation policy using an attention mechanism, according to aspects of the present disclosure.

FIG. 5 shows a flow diagram for a method of optimizing the analysis of video frames, according to aspects of the present disclosure.

FIG. 6 shows a flow diagram for a method of processing a plurality of video frames using a policy network decision model, according to aspects of the present disclosure.

FIG. 7 shows a flow diagram for a method of identifying activated filters for video analysis, according to aspects of the present disclosure.

FIG. 8 shows a block diagram of a policy network decision model, according to aspects of the present disclosure.

FIG. 9 shows a flow diagram for training a policy head decision model, according to aspects of the present disclosure.

FIG. 10 shows a block/flow diagram of a method of optimizing a network, according to aspects of the present disclosure.

FIG. 11 shows a block diagram of a video analysis system, according to aspects of the present disclosure.

FIG. 12 shows an example of a computer system, according to aspects of the present disclosure.

### DETAILED DESCRIPTION

Principles and embodiments of the present invention generally relate to using a dynamic approach in which the performed computations depend on the input data. Processing tasks, such as object detection, semantic segmentation, and action recognition can involve significant computer resources that are lacking on mobile devices, and are generally expensive. By reusing features that are consistent from input video frame (e.g., video frame) to input video frame (e.g., video frame), computational overhead may be reduced. Approaches to reducing system demands and processing power for such tasks are provided, such that the computational complexity, memory footprint, and bandwidth requirements of video processing neural networks may be optimized. Computations by a model may be minimized and optimized to reduce the computational overhead while maintaining sufficient accuracy.

Embodiments of the present invention provide an approach for optimizing the network architecture for different, specific tasks that reduce the network computational needs (e.g., FLOPs and Bandwidth). A dynamic approach based on the input data is provided, where dynamic changes can be made to the neural network of the machine learning model. A dynamic approach may adapt the network architecture, weights, and/or the input resolution to the content of the input, which may dynamically reduce computations for a wide range of video processing networks. The computations that are performed can depend on the input data, for example, detecting a black-to-white transition in an image can involve less computation.

Real-time video neural networks (NNs) applications can involve significant computing resources that can be expensive and may be lacking on edge, mobile, and personal electronic devices. A video sequence, however, can contain a high level of temporal redundancy, where the features of the video frames remain consistent for the duration of a scene, and therefore contain information redundancy. Both the foreground objects and the backgrounds of video images may remain the same (e.g., consistently contain the same visible features) between adjacent frames during extended periods of the video. Temporal redundancies, therefore, may emerge, such as similar content appearing in multiple video frames for various tasks. Even temporally distant frames can have multiple image features in common, where a majority of the image features reoccur or remain consistent between changes in scenes. Therefore, much of the image information can be repetitive and redundant. Other temporal signals (e.g., radar, lidar, depth maps, satellite image sequences, thermal imaging, etc.) can also have periods in which image features are redundant in time.

Conventional neural networks (NNs) may process an entire video frame-by-frame, without exploiting this redundancy and inherent informational sparsity. However, by dynamically pruning a neural network utilizing filters and/or multiple channels per input video, the inherent informational sparsity can be utilized to save computational overhead, while limiting an effect on the network performance in a video processing task. A large sized network may learn a complicated task and be subsequently pruned. Network pruning may involve removing parameters that would not impact the network accuracy, where network pruning can be accomplished by removing redundant and duplicate connections. There can also be channel/filter redundancy because the network may be trained on more data than a single input sample (e.g., image or video frame(s)), where some of the learned features/filters are irrelevant or redundant. Computational efficiency can be increased by skipping filters that are irrelevant to images being processed. The memory storage and computational overhead may, thereby, be reduced.

Each channel may represent a color (e.g., Red-Green-Blue (RGB)), and each pixel may be associated with three channels (e.g., RGB). An RGB image having a width (W) times a height (H) times a number of channels (C), can be described as a matrix, where W, H, and C denote the three dimensions of width, height, and the number of channels, respectively. When an RGB image is processed, a three-dimensional tensor may be applied to it. In comparison, a grayscale image has a singled channel, where the matrix values for W and H represents the intensity of light.

A deep convolutional neural network (CNN) can include a variety of different layer types. Convolution layers perform an inner product calculation of a filter (e.g., kernel) on the underlying receptive field followed by a nonlinear activation function for the local portions of the input to generate feature maps. In a CNN, each channel of a layer can be associated with the channels of a next layer. A convolutional layer can receive a 2-dimensional matrix for each channel, as input, and a filter (e.g., kernel) can be applied to the input. The convolutional layers in the CNN may apply learned filters to the input video frames (e.g., images) to generate feature maps that summarize the presence of features in the video frames, where feature maps may be generated separately for each channel. The video frames (e.g., images) may be tensors that may be input into the CNN, where the video frames can include pixels. Changes in the position of the feature(s) in the input video frame(s) can result in a different feature map for each video frame, however features may be redundant through a sequence of the video frames.

Convolution operations can be more efficient than fully connected computations because convolution operations keep high dimensional information as a 3D tensor, rather than flattening the tensors into vectors, where doing so removes the original spatial information. Convolution layers can utilize significantly fewer coefficients compared to a fully connected layer (FCL), at least partially due to the repetitive use of the filters.

In a real-time neural network video system, the computations (e.g., FLOPs and Bandwidth) in a neural network can be reduced by dynamically pruning (e.g., skipping) some of the channels/filters, copying the results from past (and future) images, and/or scaling the results.

In various embodiments, the channels and filters that can be skipped or copied and their scaling factor can be calculated by light-weight policy networks. The light-weight policy networks may aggregate information from past and future frames in order to improve the policy network's capacity to identify redundancies between video (image) frames. The policy network may find redundant computations during inference that can be omitted. The decision-making process by the policy network may become more accurate and efficient by aggregating a broader range of temporal information from the video frames. A self-attention mechanism may be utilized to compare and merge the feature descriptors from all available frames. A lightweight neural network may relate to a deep network with sufficiently fewer parameters to be implemented in resource-limited hardware, such as embedded systems, where processor and memory capacity may be more limited.

To improve the neural network, 2D convolutional layers (e.g., X-Y arrays), which can include a series of 2D convolutions of 3D tensors resulting in a 3D output tensor, per instance in the batch, and depth-wise convolutions, which can include a series of 2D convolutions of 2D tensors resulting in 3D output tensor, per instance in the batch, may be replaced with a light weight version after redundant or less crucial filters have been removed from a processing pipeline (e.g., skipped).

In various embodiments, a policy head PH can calculate the per channel policy using a trained neural network component. A per-layer lightweight policy neural network may be utilized to make a per-filter decision regarding the filter's processing value, and the filter's application to the video frame processing task. Various filters may be retained, while other filters may be scaled down or skipped, based on the determinations of the per-layer lightweight policy neural network.

In various embodiments, a plurality of video frames may be analyzed to obtain a temporal context of video frame features. Temporal aggregation may be utilized using self-attention between past, present, and possibly future input tensor descriptors.

The various embodiments of the disclosure may provide a dynamic mechanism involving Temporal Attention-based Pruning and Scaling (TAPS). TAPS can utilize lightweight policy networks to make channel-wise filter pruning decisions based on features accumulated from the sequential video frames of a video. The features from all past frames, and future frames when processing a video offline, may be processed. The neural networks can identify redundancies and predict which filters may be omitted, and may scale the remaining filters by a multiplicative scaling factor. Temporal attention may be used within the policy network. TAPS can be applied to a variety of video architectures, and can obtain an improved accuracy-efficiency trade-off, for example, for an action recognition task.

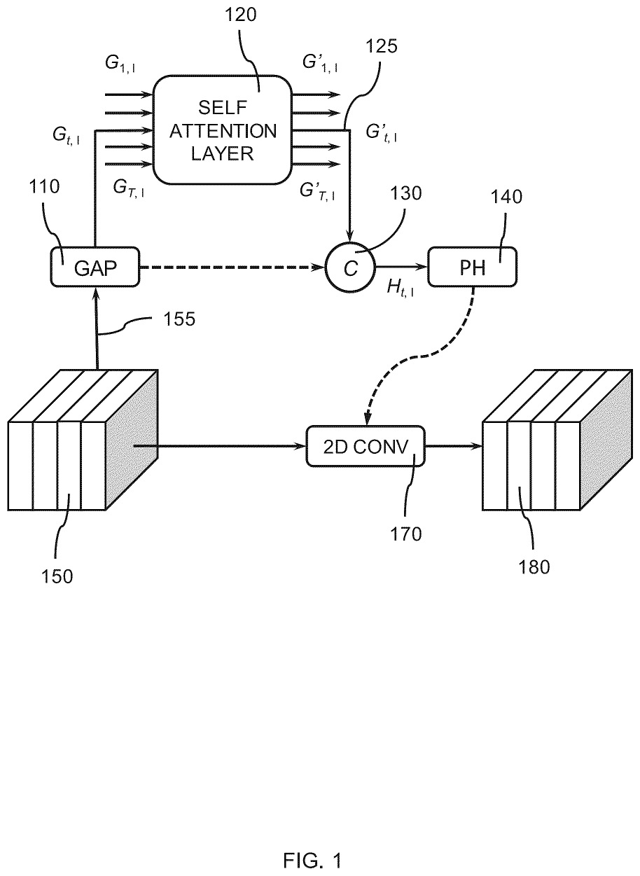

FIG. 1 is an illustrative depiction of a schematic diagram showing an attention mechanism applied to dynamic channel pruning and scaling, according to aspects of the present disclosure.

In various embodiments, the aggregation of information, as input to the policy head (PH) 140 network, may be done using a self-attention mechanism 120 (e.g., layer). A video may include a plurality of video frames, t, from 1 to T, where each video frame may include one or more channels C. A 2D CNN may be configured to process each video frame, t, of a video. The video frames may be processed by the CNN to generate feature maps, [symbol] , for layer, [symbol] .

In various embodiments, the input feature map may be denoted as:

[symbol] ∈ [symbol]
where [symbol] is a layer 1, t is a frame t, and C is a channel C. Frame t may be in a range from 1 to T, where T is the last frame of a video. Channel C may be the RGB channels of the video frames. Layer [symbol] may be the layers from 1 to L of the neural network. Gₜ is the global descriptor for the image, t, and G′ₜ is the output 125 of the attention mechanism for image frame, t, and [symbol] and [symbol] are the global descriptor and the output of the attention mechanism for the image t and layer [symbol] respectively, which may be input to the network of the policy head 140. The policy head 140 may calculate a policy per channel, C.

At operation 155, the feature maps 150 generated from video frames may be input to the global average pooling (GAP) operator 110. The video frames from 1 to t may be converted to feature maps, [symbol] . One or more features in a subset of the plurality of adjoining video frames may be detected, where the detected feature(s) may be redundant in each of the video frames. The temporal information associated with the detected features may be aggregated. A temporally consistent feature may be identified in the subset utilizing the aggregated temporal information.

In various embodiments, a global average pooling (GAP) operator 110 may perform a global average pooling (GAP) operation on a plurality of feature maps, [symbol] , to generate a GAP descriptor vector, [symbol] , for each feature map, [symbol] , where the descriptor vector may, [symbol] , be a 1×1×Z vector. The global average pooling (GAP) operation can separately determine an average value for each feature map, where each feature map may relate to a video frame. The GAP operation may reduce the spatial dimensions of the input feature maps by computing the average of all the activations in each feature map. The global average pooling (GAP) operator 110 may generate the 1×1×Z GAP descriptor vector, as output. The descriptor vector, [symbol] , for each feature map, [symbol] , from 1 to t may be provided to the attention component 120 to generate [symbol] , for each feature map, [symbol] , from 1 to t.

In various embodiments, a multiplicative scaling factor can be used to adjust the values of the filter based on calculations by the policy head (PH) network 140.

In various embodiments, a concatenator (C) 130 may perform a concatenation operation on the GAP descriptor vector, [symbol] , output by the GAP operator 110 for feature map, I_{t,1}, and the Attention component output [symbol] , for GAP descriptor vector, G_{t,1}, output by the attention component 120. The concatenator (C) 130 may generate a concatenated vector, [symbol] .

In various embodiments, attention component 120 may be a temporal attention component (TAC) configured to capture global dependencies between video frames by applying lightweight, multi-head, self-attention operations between the GAP descriptors, { [symbol] }_{t∈1, . . . , T,} to generate temporally aggregated descriptors, { [symbol] }_{t∈1, . . . , T,} that may be input to the policy head (PH) 140. In various embodiments, a policy head (PH) 130 may be applied to the concatenated vector, [symbol] , output by the concatenator (C) 130.

In various embodiments, the global descriptor and the output, [symbol] and [symbol] , may be input to a concatenator (C) 130, that can concatenate the two vectors to form an output vector.

The output of a 2D convolution is:

$$= φ ( * + )$$

where φ denotes the activation function, [symbol] ∈ [symbol] denotes the convolution filters of kernel size k×k, and [symbol] ∈ [symbol] is the bias.

In various embodiments, the policy head (PH) 140 can indicate which 2D convolutions 170 (e.g., filter, kernel) should be applied to a current feature maps 150 (e.g., at time to generate the feature maps 180 for the current video frame (e.g., at time t+1), where the active filters can be identified by a mask, [symbol] . Matrix weights from an encoder of the attention component 120 may be used for implementing the policy head 140.

In various embodiments, the policy network decision model 800 receives [symbol] as input and computes a sparse per-output-channel mask, [symbol] ∈[0, 1] [symbol] , such that:

$$= φ ( ⊙ [ * + {b}_{ℓ} ] ) ;$$

where ⊙ denotes a channel scaling operator, where if [symbol] [i]=0, the i^{th} filter is skipped (e.g., deactivated). The global average pooling (GAP) operator 110 may perform a Global Average Pooling (GAP) operation on the feature maps, [symbol] , resulting in a vector, [symbol] The per-channel descriptor can be used as the input token to the attention module 120.

A dynamic method can adapt the network architecture to the input data. In various embodiments, two consecutive video frames at times t and t+1 may be processed by one convolutional layer (e.g., layer 1), where the application of the global average pooling (GAP) operator 110, attention component 120, and policy head 140 to a video frame, from 1 to t, can dynamically change the filters applied to a subsequent video frame, t+1, through the generation and application of mask, [symbol] .

In various embodiments, a global average pooling (GAP) operator 110 may perform a global average pooling (GAP) operation on a plurality of feature maps, I_{t,1}, to generate a GAP descriptor vector, [symbol] , for each feature map, where the descriptor vector may, [symbol] , be a 1×1×Z vector. The global average pooling (GAP) operation can separately determine an average value for each feature map, where each feature map may be a video frame. The GAP may reduce the spatial dimensions of the input feature maps by computing the average of all the activations in each feature map. The global average pooling (GAP) operator 110 may generate the 1×1×Z GAP descriptor vector.

In various embodiments, the global average pooling (GAP) operation can utilize a multiplicative scaling factor, where the multiplicative scaling factor can adjust the values of a filter.

In various embodiments, a concatenator (C) 130 may perform a concatenation operation on the GAP descriptor vector, G_{t,1}, output by the GAP operator 110 for feature map, I_{t,1}, and the attention component output G′_{t,1}, for GAP descriptor vector, G_{t,1}, output by the attention component 120. The concatenator (C) 130 may generate a concatenated vector, H_{t,1}.

In various embodiments, attention component 120 may be a temporal attention component (TAC) configured to capture global dependencies between frames by applying lightweight, multi-head, self-attention operations between the GAP descriptors, { [symbol] }_{t∈1, . . . T,} to generate temporally aggregated descriptors, { [symbol] }_{t∈1, . . . , T,} that may be input to the policy head (PH) 140. In various embodiments, a policy head (PH) 130 may be applied to the concatenated vector, H_{t,1}, output by the concatenator (C) 130.

The attention component 120 may be an attention unit, a multi head attention (MHA) unit, or a sequence of MHA units.

In various embodiments, a single attention layer may account for the relations between pairs of frames, and two consecutive attention layers may be utilized to capture more complex temporal features and improve performance.

In various embodiments, the scaling operation may be used in conjunction with channel pruning. Dynamic skipping of entire filters may be utilized to reduce computational loads and improve efficiencies with additional FLOPs reduction but smaller accuracy degradation.

In an offline mode, all the frames may be available in advance, so attention may be performed between all GAP descriptors. In an online mode, only the previous frames may be available, so attention may be calculated between the current GAP descriptor and past GAP descriptors.

In an offline mode, future images of the video may be used to compute the sparse convolution, whereas in an online mode, computations would be restricted to past video frames (e.g., in a surveillance video).

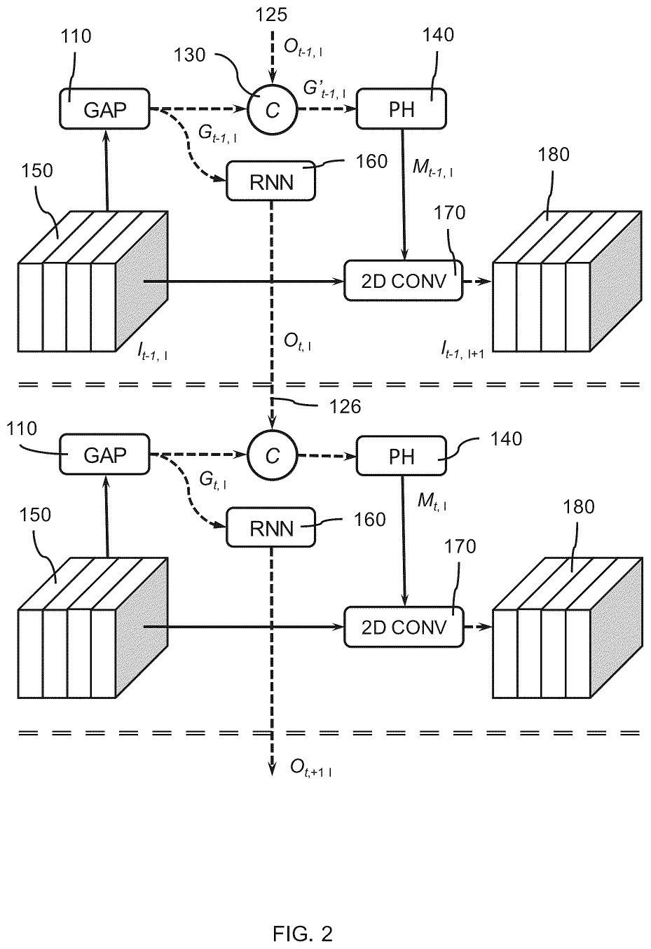

FIG. 2 is an illustrative depiction of a schematic diagram showing a temporal aggregation policy for dynamic channel pruning and scaling for two consecutive video frames, according to aspects of the present disclosure.

In various embodiments, the previous video frames may be analyzed, where a sliding window may be applied to the sequence of video frames.

In various embodiments, a feature map 150 for frame t−1 and layer [symbol] , [symbol] , may be processed by GAP 110 to generate global descriptor, [symbol] , which may be input to the concatenator (C) 130 and the temporal feature aggregator 160. The output, [symbol] , 125 from the temporal feature aggregator 160 generated from a previous frame, t−1, may be input to the concatenator (C) 130 with the global descriptor, [symbol] , for frame t−1. The output, [symbol] , 126 from the temporal feature aggregator 160 generated from a previous frame, t−1, may be input to the concatenator (C) 130 with the global descriptor, [symbol] , for the current frame, t. The processes can be repeated for each subsequent video frame, where the temporal feature aggregator 160 can capture the accumulating temporal context information. The concatenator (C) 130 can perform a concatenation operation to generate an output vector.

In various embodiments, the temporal feature aggregator 160 may be, for example, a recurrent neural network (RNN), where the RNN can propagate information between video frames.

In various embodiments, the policy network head can perform both a channel pruning (e.g., skipping) process and a scaling process, which may involve not activating a filter. The scaling may be done using the softmax layer giving the output channel a multiplicative scaling factor in the range of (0, 1). The policy network may predict a multiplicative scaling factor for each computed channel. The pruning may be done using the gumbel softmax sampling technique, where the scaling would be applied only to the channels that were not previously skipped.

In various embodiments, a global average pooling vector can take an average value of each input channel of a tensor to obtain a global descriptor of an input tensor. Other examples might be per channel variance or per channel histogram values.

In various embodiments, a processing block receives, as input, the above global descriptor and propagates information between video frames, as a Temporal feature aggregation operator. The block may be, for example, a recurrent neural network (RNN) block, a Gated Recurrent Unit (GRU) component, or Long-Short-Term Memory (LSTM) component. The processing block may also be an attention unit, a multi head attention (MHA) unit, or a sequence of MHA units.

In various embodiments, a light weight neural network having a negligible size compared to the full neural network, can receive the aggregated information, as well as the global descriptor, and make a per filter (output channel) decision. The per filter decision can be to compute the filter, skip the filter, reuse a channel, or scale a channel. Skipping a filter can be mathematically equivalent to placing zeros or a constant value in all the output channel pixels. Channel reuse may involve copying an output channel from a previous video frame, which may be the last video frame or another previous video frame, where a video frame may be from the past, or also in the future for offline video processing. Channel scaling can involve determining a value for a per channel boosting parameter or suppression parameter by a policy network.

In various embodiments, convolution operations may be pruned based on a determination of the of the policy network. One or more channels may be removed or copied, where the output of a video frame may be reused as output for a current video frame.

In various embodiments, the temporal feature aggregator 160 can perform a temporal feature aggregation operation, where the temporal feature aggregator 160 may be a recurrent neural network (RNN) block, a gated recurrent unit (GRU) component, or a long-short term memory (LSTM) component.

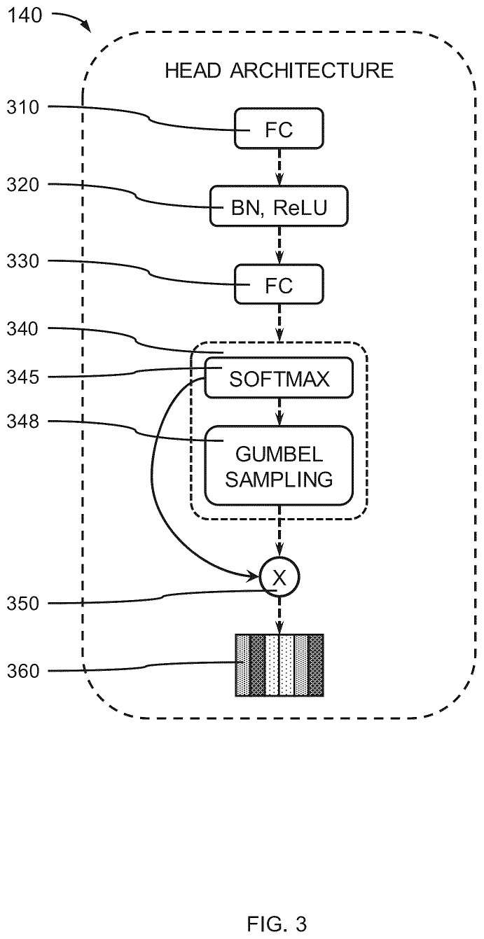

FIG. 3 shows a block diagram of an example of a policy network head architecture, according to aspects of the present disclosure.

In various embodiments, the policy head (PH) 140 can perform both a channel pruning (e.g., skipping) and a scaling operation. The scaling may be done using the softmax layer 345 giving the output channel a multiplicative factor in the (0, 1) range. The pruning may be done using the gumbel softmax sampling 348 technique. The scaling may be applied to the filters/channels that were not skipped.

In various embodiments, the policy head 140 may predict which filters can be omitted (e.g., deactivated) and which channels may be reused, as well as scale the remaining (e.g., activated) filters by a multiplicative weight factor, where the scaling may be a soft scaling. The policy head (PH) 300 may be applied to all past video frames and may apply an attention component to the features of all past video frames.

In various embodiments, the policy head (PH) 300 may include a multi-layer perceptron (MLP) having a pair of fully-connected (FC) layers 310, 330 separated by a BatchNorm (BN) and ReLU layer 320, which is followed by Gumbel-SoftMax 340. The BatchNorm portion of the BatchNorm and ReLU layer 320 can help ensure that the feature values are on the same scale and help stabilize the network during training. The ReLU portion of the BatchNorm (BN) and ReLU layer 320 utilizes a rectified linear activation function (ReLU) to output the same value as the input if the input value is positive and output a zero value otherwise. The Gumbel-SoftMax component 340 utilizes a softmax layer 345 and Gumbel sampling 348. The Gumbel-SoftMax component 340 can generate the mask 360, [symbol] , where the softmax layer 345 and Gumbel sampling 348 can perform a discrete masking operation. The scaling can be accomplished using the softmax layer giving the output channel a multiplicative factor in the (0, 1) range. The pruning is done using the gumbel softmax sampling technique. The scaling is applied only to the channels that were not skipped. The binary mask can determine which channels to skip, and the remaining channels can be multiplied by the scaling mask.

In various embodiments, the policy head (PH) 140 includes a multi-layer perceptron (MLP) having a pair of fully-connected layers separated by a BatchNorm layer and ReLU layer, which is followed by Gumbel-SoftMax. A Sigmoid function may be applied. The BatchNorm layer can help ensure that the feature values are on the same scale and help stabilize the network during training. The ReLU layer utilizes a rectified linear activation function (ReLU) to output the same value as the input if the input value is positive, and output zero otherwise. The Gumbel-SoftMax utilizes Gumbel sampling followed by a SoftMax layer.

In various embodiments, during inference, values below 0.5, for example, may indicate filters that can be omitted (e.g., deactivated). The Sigmoid output may be used as a multiplicative factor to dynamically scale the remaining channels according to an importance factor.

In various embodiments, the binary mask determines which channels to skip, thereby avoiding nonessential computations in both the current convolution layer, such that there may be fewer output channels, and in a subsequent layer, so there may be fewer input channels, while the remaining channels can be multiplied by a scaling mask. The redundant components and unnecessary computations may be identified and avoided, for example, by deactivating filters and reusing channel values.

In various embodiments, the policy head (PH) 300 may generate binary output for each filter (kernel) indicating whether the particular filter is activated. The PH output may be 0 to indicate deactivation for a specific filter and 1 to indicate activation of the particular filter. Activated filters may be applied to the video frame input, whereas the deactivated (e.g., inactivated) filters may be skipped to reduce the computational load. The filter may be deactivated by placing zeros or a constant value in all of the output channel pixels.

In various embodiments, a policy head 300 may be configured to generate a mask from the concatenated processed global descriptor and corresponding global descriptor, where the mask identifies deactivated convolution filters.

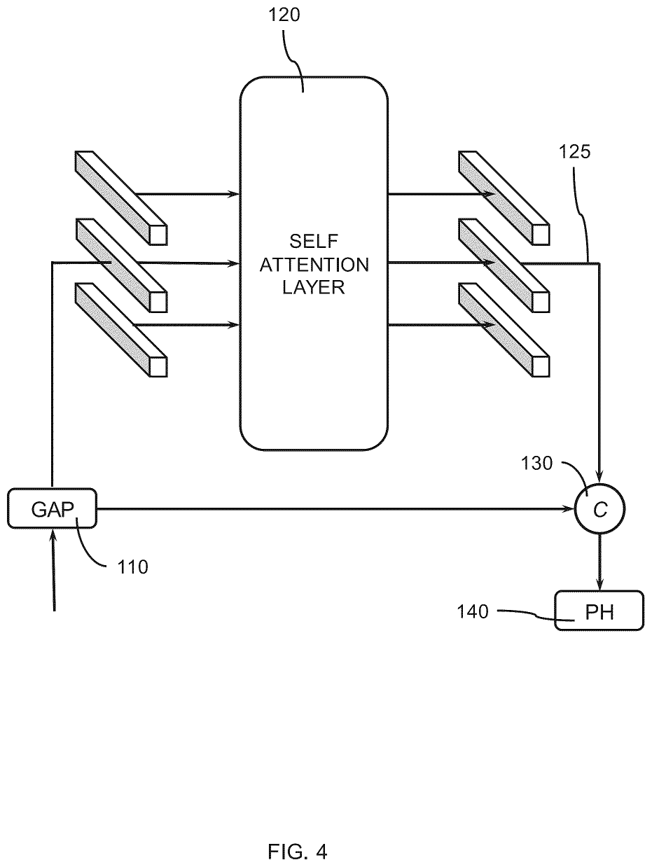

FIG. 4 is a schematic diagram of an implementation of a temporal aggregation policy using an attention mechanism, according to aspects of the present disclosure.

In one or more embodiments, the aggregation of information inputted to the policy network can be accomplished using a self-attention mechanism of the temporal aggregation component 120, where the attention mechanism can be configured to receive the global information from previously processed images from the GAP operator 110, and compute the attention between the descriptors, [symbol] . A self-attention mechanism may be utilized to compare and merge the feature descriptors from the video frames of a video, where a portion of all the video frames may be utilized to compare and merge the feature descriptors. The attention mechanism may be based on single head attention or multi head attention (MHA), and it may be implemented utilizing one or more attention blocks.

In various embodiments, Gₜ is the global descriptor for image, t, and [symbol] , is the output 125 of the attention mechanism, which may be input to the concatenator (C) 130 and policy head 140 network.

Video processing and applications can be categorized into online or offline processes. When operating online and/or in real-time, the attention for each video frame considers only the past global descriptors, whereas in an offline/non-real-time operation, subsequent images and/or global descriptors may be considered. In online applications and operations, the video frames are processed sequentially in the order the frames are received, and the algorithm/system returns a response for each video frame, before processing of the next video frame begins. In offline applications and operations, the algorithm/system may receive an entire video (e.g., video camera recording, movie clip, etc.), and process the entire set of video frames before returning its answer(s). In the online scenario, information for the policy network is accumulated over time.

In a non-limiting exemplary embodiment, for an online/real-time operation, the RNN/LSTM/GRU module is unidirectional, and accumulates global average pooling from all past video frames. The policy network compares the accumulated global average pooling to the global average pool vector from the current frame.

In a non-limiting exemplary embodiment, for an offline/non-real-time operation, the RNN/LSTM/GRU module is bidirectional and accumulates both past and future information.

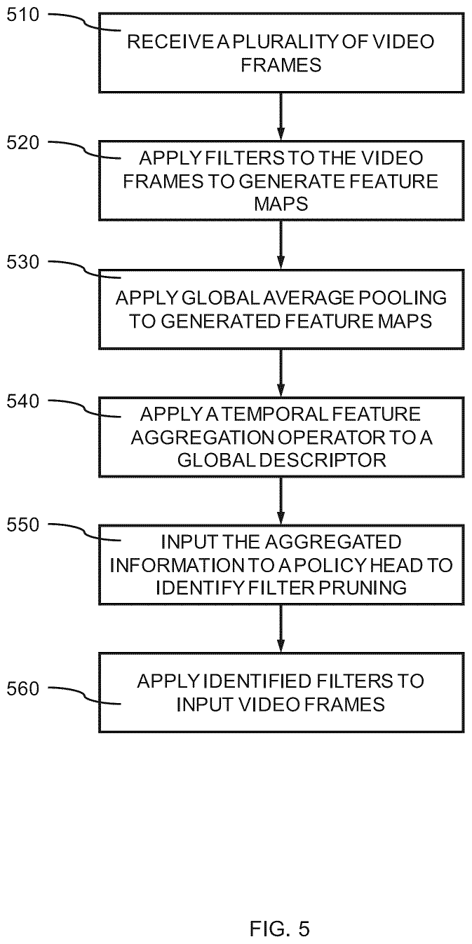

FIG. 5 shows a flow diagram for a method of optimizing the analysis of video frames, according to aspects of the present disclosure.

In various embodiments, the analysis of video frames for one or more video processing tasks may be optimized by pruning one or more filters for subsequent generation of a feature map. Reduction in the number of filters applied to a video frame can reduce the number of computations and the storage of calculated values in memory.

At operation 510, a video analysis system may receive a plurality of video frames, where the plurality of video frames can form a portion of a video.

At operation 520, one or more filters (e.g., kernels) can be applied to a video frame, where the application of a filter can generate a feature map. A plurality of feature maps may be generated for each frame of the video.

At operation 530, a global average pooling (GAP) operation may be applied to the feature maps, where the global average pooling operation may calculate an average value for each feature map and generate a GAP descriptor vector. The GAP operation can generate a GAP descriptor vector configured for input to an attention component.

At operation 540, a temporal feature aggregation operator can be applied to a GAP descriptor vector, where the temporal feature aggregation operator can be applied to a plurality of GAP descriptor vectors to aggregate a range of temporal information from the video frames. A self-attention mechanism may be utilized to compare and merge the feature descriptors from all available frames.

At operation 550, the aggregated temporal information may be input into a policy head, where the policy head can apply a policy network decision model to an input vector to identify filters for pruning. The policy network decision model may output a mask, which may be a binary mask that identifies filters that are activated or deactivated, and channels that may be copied or scaled.

At operation 560, the filters identified as activated based on previous video frames may be applied to a current input video frame to generate new feature masks for the current video frame.

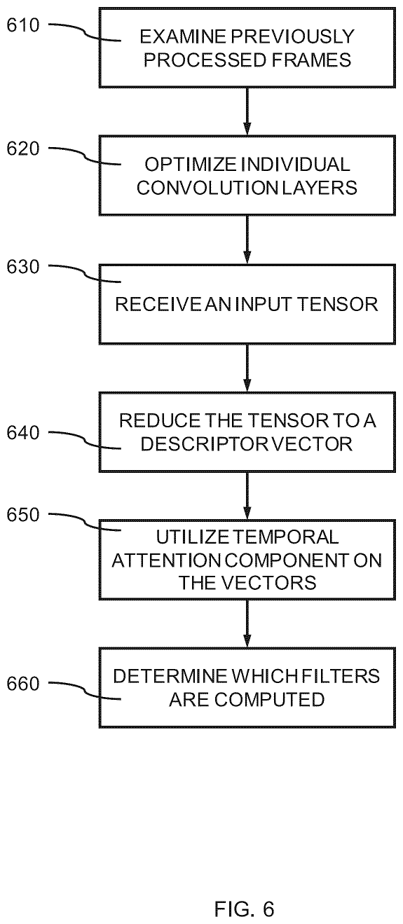

FIG. 6 shows a flow diagram for a method of processing a plurality of video frames using a policy network decision model, according to aspects of the present disclosure.

At operation 610, previously processed video frames may be examined to aggregate contextual information over time. The previous frames may be processed by a temporal attention component (TAC).

At operation 620, the convolution layers may be optimized by identifying filters to be deactivated, where optimization may be implemented per channel.

At operation 630, an input tensor may be received by the system.

At operation 640, the input tensor may be reduced to a smaller descriptor vector, where global average pooling may be used to reduce the input tensor.

At operation 650, the temporal attention component may be used on the input descriptor vectors.

At operation 660, a policy head can determine which filters are to be computed.

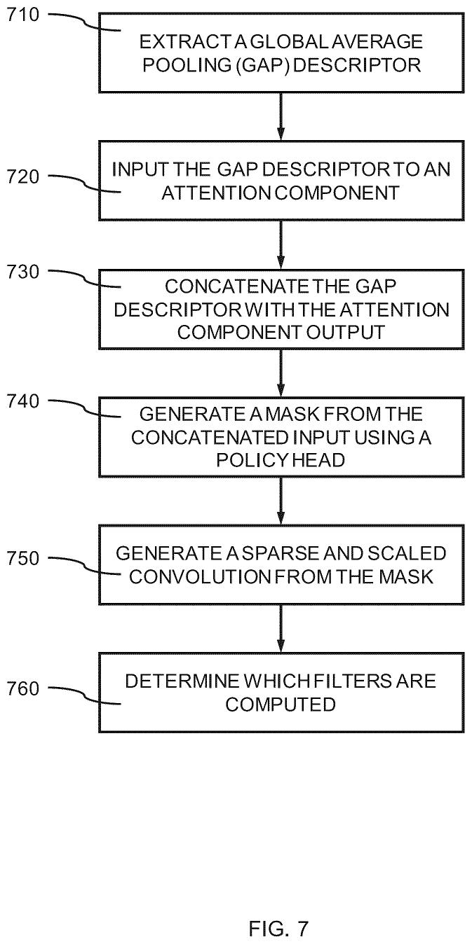

FIG. 7 shows a flow diagram for a method of identifying activated filters for video analysis, according to aspects of the present disclosure.

In various embodiments, a video analysis system can be optimized by identifying activated filters for video analysis.

At operation 710, a global average pooling (GAP) descriptor (e.g., a vector) can be extracted from each of the video frames.

At operation 720, the GAP descriptor can be input to a temporal attention component (TAC).

At operation 730, the processed GAP descriptor output by the temporal attention component (TAC) may be concatenated with the original, corresponding GAP descriptor to form an input for a policy head network.

At operation 740, the policy head network may generate an output mask from the concatenated input.

At operation 750, sparse and scaled convolutions can be identified from the mask.

At operation 760, the filters are computed for a subsequent image are determined based on the mask.

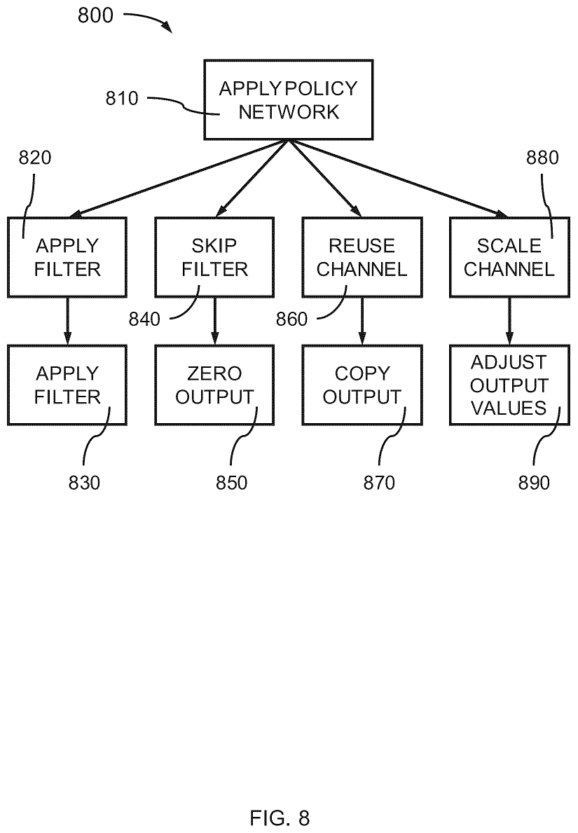

FIG. 8 shows a block diagram of a policy network decision model, according to aspects of the present disclosure.

In various embodiments, the policy head 140 can utilize a policy network decision model 800 on the concatenated input, where the policy network decision model 800 may determine which filters to apply to the convolution operations. The policy network decision model 800 overhead may be less than 1% of the network FLOPs.

The policy network decision model 800 may perform a discrete pruning decision function. The policy network decision model 800 may be trained using an adapted Gumbel-SoftMax reparameterization trick in placer of backpropagation to approximate the discrete binary decision using a differentiable Gumbel-Sigmoid relaxation during training.

In various embodiments, cross entropy loss, [symbol] ₜₐₛₖ, may be used for training the policy network decision model 800, where loss function can provide a model for reduced computation through channel pruning, while maintaining accuracy.

In various embodiments, the output from the policy head 140 can be based on applying a policy network decision model 810 to the input vector, where the policy network decision model 800 can determine whether a filter is activated or deactivated, or a channel is reused or scaled.

At block 820, a filter may be identified by the policy network decision model 810 as an active filter, where the filter values (e.g., weight) may be retained and applied in a convolution calculation (830).

At block 840, the filter may be deactivated by replacing the filter values with zeros or a constant (850).

At block 860, the channel may be reused by copying a previous set of output values 870 to the current output channels. A prior output channel may be copied from a previous frame, which may be the immediately prior video frame or another previously analyzed video frame. A future video frame also may be used in an offline video processing operation.

At block 880, the filter weights may be scaled by adjusting the values 890 through multiplication by a weight value, where the weight value can represent an importance factor of the filter. The policy network decision model 810 can calculate a per channel boosting or suppression parameter to be applied to the filter values for scaling. Scaling the filter values can boost accuracy and/or robustness, but without reducing the compute complexity and overhead.

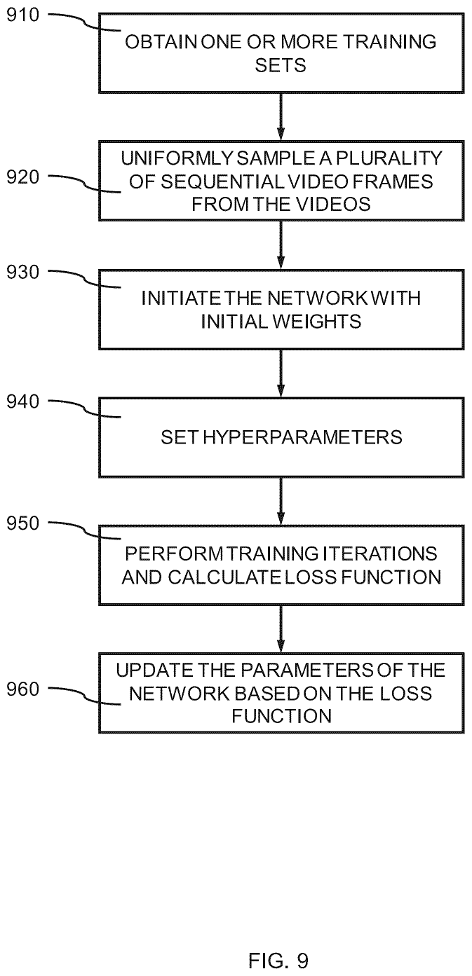

FIG. 9 shows a flow diagram for training a policy network decision model, according to aspects of the present disclosure.

In various embodiments, the policy network decision model 800 may be trained based on datasets, including, for example, Something-Something-V2 (194k/25k clips, 174 classes), ActivityNet1.3 (10k/5k clips, 200 human activities classes)), Mini-Kinetics (121k/10k clips, 200 human action classes), and Jester (119k/15k clips, 27 hand gesture classes), where the training sets may be obtained for training the network(s). Some data sets are scene-focused datasets (ActivityNet1.3, Mini-Kinetics) and some data sets are motion-focused datasets (STHv2, Jester). The training set have predefined train/validation splits.

In various embodiments, training utilizes T=8 frames uniformly sample from each video, with each frame having an input dimension of 224×224.

In various embodiments, random scaling and cropping may be applied during training, whereas center cropping may be employed during inference.

In various embodiments, ImageNet pre-trained weights may be used for network initialization, and the hyperparameters may be set as follows: 50 epochs of training, an initial learning rate of 0.01, decaying by 0.1 after 20 and 40 epochs, a batch size of 64 and a weight decay of 0.0001. The λ may be set to 0 for 10 epochs and linearly increased to 5 during the next 20 epochs.

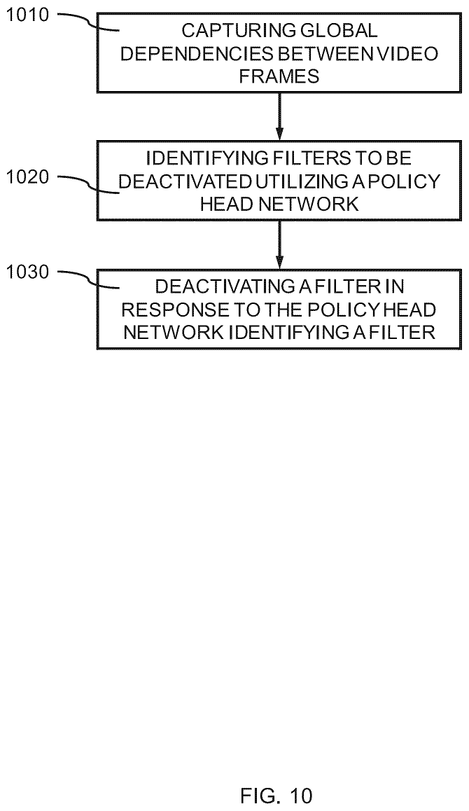

FIG. 10 shows a block/flow diagram of a method of optimizing a network, according to aspects of the present disclosure.

At operation 1010, global dependencies between a plurality of video frames may be captured using a temporal feature aggregator. The temporal feature aggregator can utilize an attention mechanism to capture redundant features in feature maps.

At operation 1020, filters to be deactivated can be identified utilizing a policy head network, where the policy head network can include a trained policy network decision model 800.

At operation 1030, a filter can be deactivated in response to the policy head network identifying one or more filters for deactivation. The policy head network can identify filters for deactivation using a binary mask.

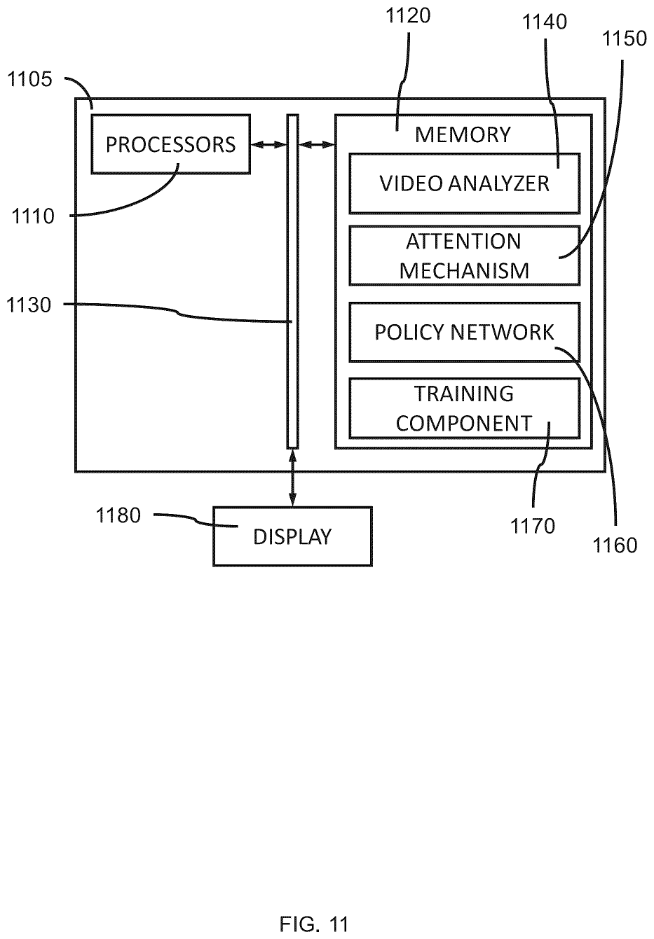

FIG. 11 shows a block diagram of a video analysis system, according to aspects of the present disclosure.

In various embodiments, a video analysis system 1105 can include one or more processors 1110, a memory 1120, and a channel 1130 (e.g., a bus) connecting the one or more processors 1110 to the memory 1120. A display 1180 (e.g., computer screen, heads-up display, vehicle infotainment screen, smartphone screen, etc.) can be connected to and in communication with the video analysis system 1105 through the channel 1130, where the output for a video analysis task can be presented to a user on the display 1180.

In various embodiments, the videos, including a plurality of video frames, may be stored in the memory 1120.

In various embodiments, the one or more processors 1110 can be a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. The one or more processors 1110 can be configured to perform one or more operations based on received instructions, where the instructions can be stored in memory 1120.

In various embodiments, the memory 1120 can be random access memory (RAM), including dynamic random access memory (DRAM) and/or static random access memory (SRAM), read-only-memory (ROM), and/or long term memory, including solid state memory, magnetic memory (e.g., a hard disk drive) optical memory (e.g., compact optical disks, blu-ray, etc.), and combinations thereof.

In various embodiments, a video analyzer 1140 configured to perform a video analysis task for a video analysis system 1105 can be stored in the memory 1120, where the video analyzer 1140 can include one or more neural networks (e.g., a CNN, RNN, LSTM, transformer, encoder/decoder, etc.). The video analyzer 1140 can analyze one or more videos for object detection, semantic segmentation, action recognition, etc. The video analyzer 1140 can be configured to perform convolution operations, feature map generation, and policy determinations. The neural networks, including associated weights and parameters, can be stored in the memory 1120.

In various embodiments, an attention mechanism 1150 can be stored in the memory 1120, where the attention mechanism 1150 can be a neural network (e.g., a CNN, RNN, LSTM, transformer, encoder/decoder, etc.) configured to perform an attention operation on feature maps. The attention mechanism 1150 can aggregate information over a duration of a video, where the aggregated information may be used to optimize the video analysis task(s). The attention mechanism 1150 may be based on a training set and a loss function, where the attention mechanism 1150 may be stored in the memory 1120.

In various embodiments, a policy network 1160 can be stored in the memory 1120, where the policy network 1160 may be configured to apply a policy network decision model 800 to a video. The policy network 1160 can be configured to identify filters that may be skipped and channels that may be reused or scaled.

In various embodiments, a training component 1170 can be stored in the memory 1120, where the training component 1170 can be configured to obtain training sets and train the neural networks (e.g., a CNN, RNN, LSTM, transformer, encoder/decoder, etc.) by adjusting weights based on a loss function. The training component 1170 may utilize training sets including video frames, where the training sets may be stored in the memory 1120.

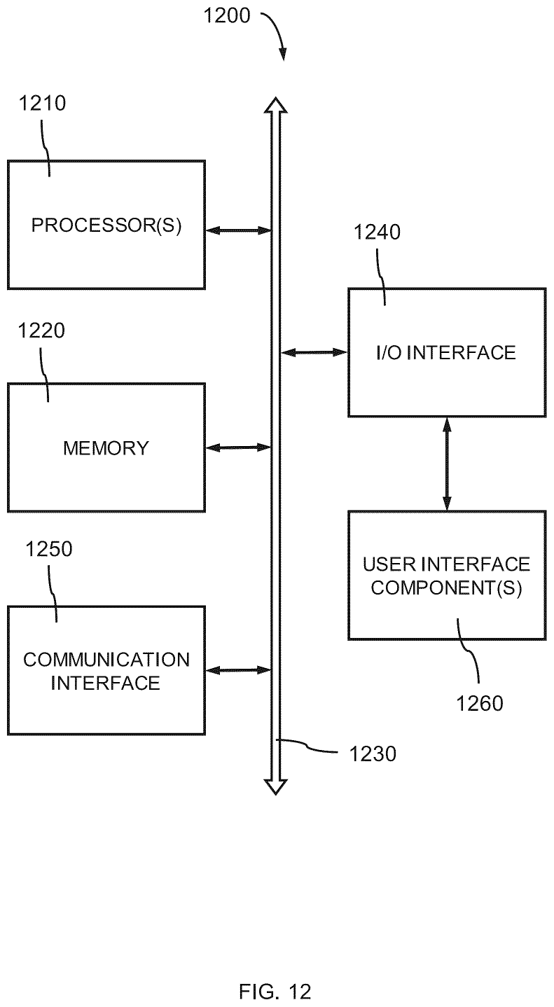

FIG. 12 shows an example of a computer system, according to aspects of the present disclosure.

In an aspect, the computer device 1200 includes processor(s) 1210, memory subsystem 1220, channel 1230, I/O interface 1240, communication interface 1250, and user interface component(s) 1260. In various embodiments, a computer device 1200 can be configured to perform the operations described above and illustrated in FIG. 1-11.

In various embodiments, computer device 1200 is an example of, or includes aspects of, a video analysis system 1105 of FIG. 11, where the computer device 1200 can be an on-board vehicle computer, a smartphone processor, an embedded system, etc. In various embodiments, computing device 1200 includes one or more processors 1210 that can execute instructions stored in memory subsystem 1220, where the instructions can be for a neural network model.

According to various aspects, computing device 1200 includes one or more processors 1210. In various embodiments, a processor 1210 may be an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor 1210 is configured to operate a memory array using a memory controller. In other cases, a memory controller is integrated into a processor 1210. In some cases, a processor 1210 is configured to execute computer-readable instructions stored in a memory subsystem 1220 to perform various functions (e.g., video analysis). In various embodiments, a processor 1210 includes special-purpose components for modem processing, baseband processing, digital signal processing, or transmission processing.

According to various aspects, the memory subsystem 1220 includes one or more memory devices. Examples of a memory device include random access memory (RAM), read-only memory (ROM), solid state memory, and a hard disk. In various embodiments, memory is used to store computer-readable, computer-executable software including instructions that, when executed, cause a processor to perform various functions described herein. In some cases, the memory subsystem 1220 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to various embodiments, communication interface 1250 operates at a boundary between communicating entities (such as computing device 1200, one or more user devices, a cloud, and one or more databases) and channel 1230 (e.g., bus), and can record and process communications. In some cases, communication interface 1250 is provided to enable a processing system coupled to a transceiver (e.g., a transmitter and/or a receiver). In some examples, the transceiver is configured to transmit (or send) and receive signals for a communications device via an antenna.

According to some aspects, user interface component(s) 1260 enable a user to interact with computing device 1200. In some cases, user interface component(s) 1260 include an audio device, such as an external speaker system, a microphone, an external display device such as a display screen, an input device (e.g., a remote control device interfaced with a user interface directly or through the I/O controller), or a combination thereof. In some cases, user interface component(s) 1260 include a graphical user interface (GUI).

According to various aspects, I/O interface 1240 is controlled by an I/O controller to manage input and output signals for computing device 1200. In various cases, I/O interface 1240 manages peripherals not integrated into computing device 1200. In various cases, I/O interface 1240 represents a physical connection or a port to an external peripheral. In various cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a user interface component(s) 1260, including, but not limited to, a modem, a keyboard, a mouse, a touchscreen, or a similar device. In some cases, the I/O controller is implemented as a component of a processor. In some cases, a user interacts with a device via I/O interface 1240 or via hardware components controlled by the I/O controller.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of optimizing a network comprising:
obtaining a video comprising a plurality of video frames;
computing, using a machine learning model, a global dependency value based on the plurality of video frames;
deactivating a filter of the machine learning model based on the global dependency value; and
processing, using the machine learning model, at least a portion of the video based on the deactivated filter.

2. The method of claim 1, further comprising:
scaling an active filter of the machine learning model by a multiplicative scaling factor based on the global dependency value.

3. The method of claim 2, wherein processing at least the portion of the video comprises:
generating a feature map for a subsequent frame of the video based on the active filter.

4. The method of claim 1, further comprising:
generating a plurality of global dependency values corresponding to the plurality of video frames, respectively.

5. The method of claim 4, wherein:
the filter is deactivated based at least in part on the plurality of global dependency values.

6. The method of claim 1, wherein:
the global dependency value is generated by an attention mechanism of the machine learning model.

7. The method of claim 6, wherein:
the attention mechanism is a self-attention layer.

8. The method of claim 1, wherein:
the global dependency value is generated by a recurrent neural network.

9. The method of claim 1, wherein:
the filter comprises a filter of a convolutional layer of the machine learning model.

10. A method of dynamic channel pruning, comprising:
receiving a plurality of video frames;
generating, using a machine learning model, features corresponding to each of the plurality of video frames;
identifying a temporally consistent feature of the plurality of video frames based on the features; and
deactivating a filter of the machine learning model based on the temporally consistent feature.

11. The method of claim 10, wherein identifying the temporally consistent feature comprises:
aggregating the features using an attention mechanism.

12. The method of claim 11, wherein:
the attention mechanism is a self-attention mechanism.

13. The method of claim 10, further comprising:
adjusting weights of the machine learning by a multiplicative scaling factor based on the temporally consistent feature.

14. The method of claim 10, wherein deactivating the filter comprises:
generating a mask that identifies the filter for deactivation.

15. A video analysis system, comprising:
one or more processors; and
memory coupled to the one or more processors, wherein the memory includes instruction for:
a global average pooling (GAP) component configured to generate a global descriptor for each of a plurality of video frames;
a temporal attention component (TAC) configured to capture global dependencies between video frames based on the global descriptors and output a processed global descriptor;
a concatenation component configured to concatenate the processed global descriptor with the corresponding global descriptor; and
a policy head configured to generate a mask from the concatenated processed global descriptor and corresponding global descriptor, wherein the mask identifies deactivated convolution filters.

16. The video analysis system of claim 15, wherein:
the temporal attention component is a recurrent neural network (RNN).

17. The video analysis system of claim 15, wherein:
the temporal attention component includes an encoder.

18. The video analysis system of claim 15, further comprising:
a plurality of feature maps generated from the video frames stored in the memory.

19. The video analysis system of claim 15, further comprising:
a plurality of scaled convolutional filters identified by the mask.

20. The video analysis system of claim 19, wherein:
the mask includes a multiplicative scaling factor.
